(19) United States
(12) Patent Application Publication
(10) Pub. No.: US 2016/0276850 A1
(43) Pub. Date: Sep. 22, 2016

(54) Charging Bus

(71) Applicant: CNCI PROPERTY LIMITED, London (GB)

(72) Inventor: Christopher Shelton, London (GB)

(21) Appl. No.: 15/037,873

(22) PCT Filed: Nov. 19, 2014
(86) PCT No.: PCT/GB2014/000478

§ 371 Date: May 19, 2016

(30) Foreign Application Priority Data
Nov. 19, 2013 (GB) 1320375.7

(51) Int. Cl. H02J 7/00

(52) U.S. Cl. CPC H02J 7/0021; H02J 7/007; H02J 2007/0096

(57) ABSTRACT

An apparatus for the management of one or more power sources when connected to one or more batteries, in particular on a boat, comprises a first power source such as an engine alternator (11) connected to a first source charge manager (26) and a second power source such as a solar panel (13,14) connected to a second source charge manager (26). The first and second source charge managers (26) are connected to a rail (5) maintained over a predetermined range of voltage. The rail (5) is connected to a battery charge manager (33), which manager is connected to a battery such that the battery can be charged from at least one of the first and second power sources.

The invention relates to an apparatus and method for the management of one or more power sources when connected to one or more batteries, in particular in an environment without access to mains electricity such as on a boat.

Modern small and medium sized boats are provided with a variety of electrical equipment on board such as refrigerators, which are adapted to be powered off an on-board battery. This battery is also sometimes used for starting the on-board engine and will typically be a 12V marinised lead-acid battery. To avoid the risk that the refrigerator and other electrical equipment accidentally drain the battery, it is common to use a second battery for such equipment, often lead-acid but sometimes another type such as a nickel cadmium rechargeable battery. Such batteries ideally need to be completely discharged from time to time in contrast to a lead-acid battery. Small to medium sized boats are also often provided with a number of independent power sources such as a solar cell array in addition to the engine. However, known systems suffer from a number of problems relating to the mismanagement of the power.

The conventional approach in marine technology is simply to use a conventional charger with a three step charging process. In the first step, the charger delivers the maximum current of its capacity to the battery. The duration of this phase depends on the capacity of the battery and charger, respectively and also whether the battery is being used to power any devices such as a refrigerator at the same time. The second step begins once the battery has reached its maximum capacity, which for a lead acid battery is at about 80% of full charge. At this stage the charger current is reduced slowly over a period of several hours, during which time the battery should reach a fully charged state. The final step of this process is the supply of a float voltage to maintain the battery at or near its fully charged state.

Examples of mismanagement include:

1 The use of a solar panel to charge a 12 v battery. Such panels usually comprise 36 silicon cells which provide constant current charging at whatever the voltage of the battery—for example 13 v. But solar panels are rated at their maximum power point which is commonly a voltage of around 17 v. In this instance a 170W panel would provide 10A at 17V but would still supply 10 A when connected to a 13 v battery and thus deliver only 130W.

2An alternator on an engine is generally designed to maintain a starting battery. Such a battery is ideally rarely used and so remains fully charged and ready to start the engine. The alternator is fitted with a regulator so as not to overcharge the battery. In general alternator will charge the battery eventually but will take a long time because as the voltage rises towards the fully charged value, the alternator regulator reduces the current to small amounts. If the battery is used for some other purpose such as lighting, the alternator will behave in the same way and the battery will take some time to reach a fully charged state. A battery is best charged rapidly by delivering current as much as is available. Lead-acid batteries react to this by raising their voltage and so making it hard to deliver the charge. If the source voltage is raised the charge is delivered but care must be taken so as to not over-charge the battery by sensing when the battery charge state is reaching maximum.

3This problem is compounded when two batteries must be charged from the same source. It is common practice to provide diodes in a mains-powered charger so that several batteries can be charged at the same time. Such diodes prevent the loads from one battery from discharging another but also prevent the batteries from being optimally charged. For example if one battery is fully charged the raised voltage method can be used to get charge in more rapidly than the battery already charged will become over-charged; if the standing voltage method is used the discharged battery will take a long time to charge.

4It is very difficult to charge batteries with different chemistry simultaneously such as wet lead-acid, gel lead-acid, nickel-cadmium or lithium by connecting them with diodes as each has a different charge regime and voltage.

The present invention seeks to solve the problems encountered when multiple

electrical sources are required to charge one or, particularly more, batteries.

According to the invention there is provided an apparatus for the management of one

or more power sources when connected to one or more batteries, comprising a first power source connected to a first source charge manager and a second power source connected to a second source charge manager, wherein the first and second source charge managers are connected to a rail, which rail is maintained over a predetermined range of voltage, the rail being connected to a battery charge manager, which manager is connected to a battery such that the battery can be charged from at least one of the first and second power sources.

The invention provides an apparatus and method by which each source can be independently managed and each battery can be independently managed so that each is operated optimally.

The method and apparatus solve these problems by using a separate charge controlling device for each source and a separate device for each battery. These devices are all connected together by a common power connection, the ‘charge rail’, (referred to as Rail), so that power may be delivered to the batteries from the sources. This allows power to the charge rail to be delivered to any battery at any time depending on the batteries' needs and from any source according to its ability to provide power.

Exemplary embodiments of the invention will now be described in greater detail with reference to the drawing, in which:

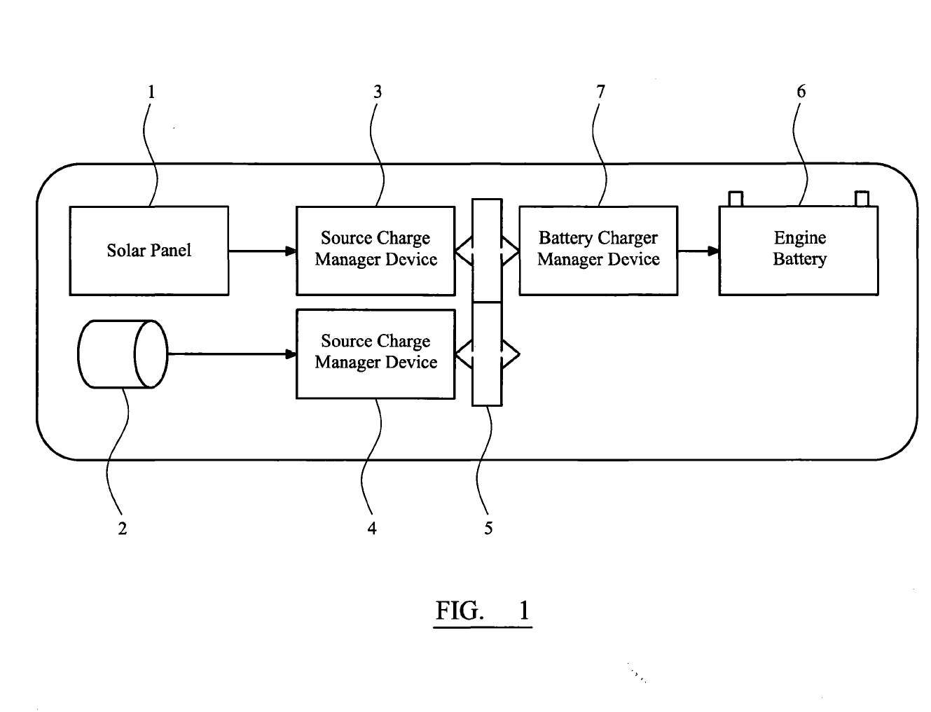

FIG. 1 shows schematically an arrangement of the charging bus;

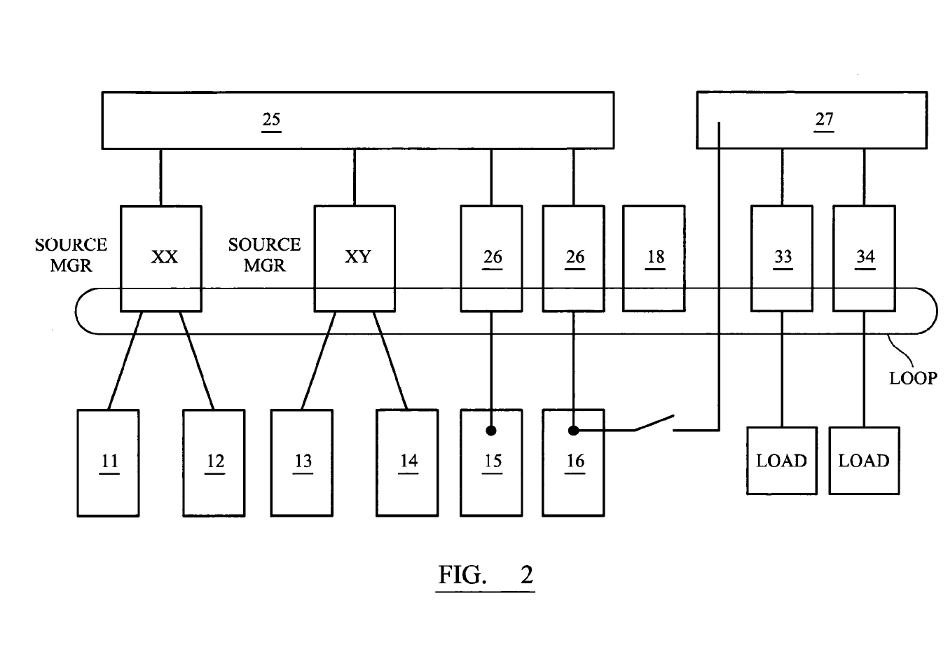

FIG. 2 shows schematically an example of a single yacht installation

FIG. 1 shows schematically an arrangement of the charging bus. The boat is provided with a first power source, solar panels 1 and a second power source, engine alternator 2. Each of the power sources 1, 2 is connected to a respective manager device 3, 4, which in turn is connected to a charging rail 5. A battery 6 is connected via charging manager 7 to the charging rail 5. The rail voltage can be chosen to be any particular voltage or range of voltage.

The basic method of operation is that sources of a lower voltage than the rail 5 get their power delivered at Rail voltage by a method which increases the voltage by the use of the respective manager device 3,4 such as an active or switching converter and sources with a voltage higher than Rail use a voltage dropping method, preferably lossless, by the respective manager device 3,4 such as a switching converter. Each such converter will be appropriate to the needs of the source as in the following examples:

1 A solar panel is ideally operated at around the maximum voltage it will operate at before the current it supplies is decreased. A nominal 12 v panel generally has such a peak power voltage around 17V. The converter to Rail therefore delivers Rail voltage but in such a way that the panel voltage does not drop much below 17V. Such a converter will deliver whatever current the panel can provide at a constant, say, 16V. If there is no demand for the power the panel voltage will increase to whatever the panel design will produce but when power is required the method is to take only that current which will maintain the panel voltage at around 17V. In such a situation the maximum power of the panel is available to the batteries. If no power is needed the panel voltage will rise to its open-circuit value.

2 An alternator such as is found on marine or vehicle engines is typically designed to maintain a starter battery and to provide vehicle power at around 13V. The internal regulator will not usually permit the alternator to deliver high currents unless the voltage drops to that of a discharged battery—say around 12V. By making the alternator always deliver power at Rail Voltage, say 16 v, by using an active power supply the alternator voltage can be reduced by the electronics in the power supply so that whatever needed current is delivered even when the engine is operated at low speeds. Also there is no requirement to modify the alternator nor its regulator in any way—the output is simply taken to the special power supply.

In a similar way to management of sources, the management of batteries is done by a dedicated charging manager 7—one to each battery. Such a power supply maintains the Rail voltage by drawing only so much current that the Rail voltage is maintained at a predetermined voltage, say, at around 16V. If current is available from whatever source is generating at the time then that power can be used to charge batteries according to each battery's needs depending on its chemistry (wet or dry lead-acid, nickel-cadmium, nickel-metal-hydride or lithium or nickel-iron). The Rail 6 will supply current at a predetermined Rail voltage to each power unit each of which contains the control regime within it to ideally charge the battery connected to it. Such a regime can take account of the battery's temperature, history as well as the needs of its particular chemistry. For each battery there is an independent charge controlling power supply so that in a typical application there might be four power units all connected together:

Solar; Alternator; Battery 1; Battery 2

FIG. 2 shows an example of a single yacht installation comprising an engine alternator 11, mains DC supply 12, first and second solar panels 13, 14, an engine battery 15 and a boat battery 16. Each of the aforesaid charging sources is connected to the common charging rail 25 and associated with each charging source type is a respective charge manager 26. A cluster controller 18 is also provided in series with the respective charge managers 26, which enables a connection via USB or Bluetooth to a computer. This provides a networking bridge which enables external controllers to be connected to the system.

The boat battery 16 is also provided with a connection to the load rail 27 which is connected to the load circuits 31 and 32 with associated load controllers 33 and 34. A control loop 35 is provided that connects in series each of the respective charge managers 26, the cluster controller 18 and the load controllers 33 and 34. The load controllers and circuits are also connected to the charging rail or bus 25.

The control loop 35 is, in this example, a polled serial data loop that allows a number of devices such as the charge managers and load controllers to be connected to the cluster controller 18. In use, the cluster controller will poll each of these in an alternate sequence of checking for a fault condition and then collecting parameters and then moving onto the next device on the bus.

The cluster controller 18 uses a short message protocol identifying the device, the input voltage and current and the output current and voltage as well as the temperature of the power source and internal device temperature.

In a further embodiment a source manager 3, 4 delivers a voltage at a slightly higher voltage than nominal Rail voltage; similarly a battery manager 7 might still deliver current when the Rail voltage is lower than nominal rail voltage. In this embodiment the power would be taken preferentially from the high source and delivered preferentially to the lower voltage battery manager. Thus by setting differences in the outputs of source managers 3, 4 and in the levels at which the battery manager(s) 7 regulate the Rail voltage a system of Priority can be enacted.

In addition each unit can communicate to a supervising controller so that not only the source managers 3, 4 and the battery manager(s) 7 can be controlled or adjusted but also the state of charge can be used to communicate to load switches so as further enhance the total system operation by, for example, load-shedding prior to when the batteries were likely to be flat.

An example of a communications method is the use of ferrite ring cores whereby a secondary winding comprising a single wire threaded through the cores and then joined. Thus all the cores were connected in the manner of a current transformer so as to proved isolated serial communications in a simplex manner at low-cost without electrical connection. The method also prevents a failure of any one unit from preventing the operational ones continue to communicate.

1. Apparatus for the management of at least one power sources when connected to at least one battery, comprising a first power source connected to a first source charge manager and a second power source connected to a second source charge manager, wherein said first and second source charge managers are connected to a rail, wherein said rail is maintained at a predetermined voltage, said rail being connected to a battery charge manager, wherein said battery charge manager is connected to said at least one battery such that said at least one battery can be charged from at least one of said first and second power sources.

2. Apparatus for the management of at least one power sources according to claim 1, wherein said at least one power sources having a lower voltage than said rail, receive power delivered at a predetermined voltage.

3. Apparatus according to claim 2, wherein said first and second source charge manager increases the voltage by an active converter.

4. Apparatus according to claim 1, wherein said at least one power sources having a voltage higher than a predetermined rail voltage use a voltage dropping method.

5. Apparatus according to claim 4, wherein said first and second source charge manager reduces the voltage by means of a switching converter.

6. Apparatus according to claim 1, wherein said apparatus is provided with a networking bridge adapted to enable control of said first and second source charge managers, said first and second source charge managers being connected by a control loop adapted to transmit and receive data.

7. Apparatus according to claim 1, wherein said apparatus further comprises a load rail, which is connected to at least one load circuits, wherein each of said at least one load circuits is associated with a respective load controller.

8. Apparatus according to claim 2, wherein said first and second source charge manager increases the voltage by a switching converter.

9. Apparatus according to claim 3, wherein said at least one power sources having a voltage higher than a predetermined rail voltage use a voltage dropping method.

10. Apparatus according to claim 5, wherein said apparatus is provided with a networking bridge adapted to enable control of said first and second source charge managers, said first and second source charge managers being connected by means of a control loop adapted to transmit and receive data.

11. Apparatus according to claim 6, wherein said apparatus further comprises a load rail, which is connected to at least one load circuits, wherein each of said at least one load circuits is associated with a respective load controller.

12. Apparatus for the management of a plurality of power sources when connected to a plurality of batteries, comprising a plurality of power sources connected to a plurality of charge managers, wherein said plurality of charge managers are connected to a rail, wherein said rail is maintained, at a predetermined voltage, said rail being connected to a battery charge manager, wherein said battery charge manager is connected to said at least one battery such that said at least one battery can be charged from at least one of said plurality of power sources.
